(19) United States
(12) Patent Application Publication
(10) Pub. No.: US 2016/0036189 A1
(43) Pub. Date: Feb. 4, 2016

(54) LOCKING TOOL FOR CO-AXIAL CONNECTOR

(71) Applicant: CHUNG-CHUAN HUANG, TAINAN CITY (TW)

(72) Inventor: CHUNG-CHUAN HUANG, TAINAN CITY (TW)

(21) Appl. No.: 14/449,266

(22) Filed: Aug. 1, 2014

(51) Int. Cl. H01R 43/26; H01R 13/639

(52) U.S. Cl. CPC H01R 43/26; H01R 13/639

(57) ABSTRACT

A locking tool includes a holding portion which is a semi-circular and cylindrical plate. Two first extensions and a second extension extend from the first distal end of the holding portion. The first extensions each are a straight extension and extend radially and outward. The second extension has a curvature the same as that of the holding portion. Two notches are defined in the first distal end of the holding portion. The holding portion holds the body of the co-axial connector and the blocks on the co-axial connector are engaged with the notches to efficiently lock or unlock the co-axial connector.

### BACKGROUND OF THE INVENTION

1. Fields of the Invention

The present invention relates to a tool, and more particularly, to a locking tool having notches for engagement with protrusions of a co-axial connector so as to easily lock or unlock the co-axial connector.

2. Descriptions of Related Art

The conventional co-axial connectors are used widely in electrical or electronic appliances such audio appliances, fiber cables, telephone wires and network broadcasting equipment. Along with the advanced manufacturing technology, the electrical or electronic appliances are made compact and light so that the parts to be connected are smaller than before as well. Therefore, the space for accommodating these parts are limited and the reception holes for receiving the co-axial connectors are smaller than before. This trend makes the locking or unlocking the co-axial connectors be difficult and longer time is required.

FIG. 1 discloses a conventional locking tool 10 which has a holding portion 101 and two slots 1011 are defined through the holding portion 101 and located corresponding to each other. The co-axial connector 20 has a flange 201 at a distal end thereof, and a first neck 202 extends from the flange 201. A guide slot 203 is defined in the first neck 202 and has an engaging portion 204. A first body portion 205 is connected to the first neck 202 and two blocks 206 are formed on the outside of the body portion 205. A second neck 207 extends from the first body portion 205 and a second body portion 208 is connected to the second neck 207. As shown in FIG. 2, when in use of the locking tool 10, the holding portion 101 accommodates the first body portion 205 and the two blocks 206 are engaged with the two slots 1011. The distal end of the holding portion 101 contacts against the flange 201.

Another co-axial connector 30 is disclosed in FIG. 3 and has a flange 301 on the distal end thereof, a first neck 302 extends from the rear side of the flange 301. A guide slot 303 is defined in the first neck 302 and has an engaging portion 304. A first body portion 305 is connected with the first neck 302 and two blocks 306 are formed on the outside of the body portion 5. A second neck 307 extends from the first body portion 305 and is longer than the second neck 207 in FIGS. 1 and 2. A second body portion 308 is connected to the second neck 307, the diameter of the second body portion 308 is larger than that of the first body portion 305. The holding portion 101 of the locking tool 10 is a hollow and cylindrical portion, when the holding portion 101 holds the second flange 308, because the diameter of the second flange 308 is larger than the first body portion 305, so that the holding portion 101 cannot hold and match with the first body portion 305 properly, and blocks 306 cannot be properly engaged with the slots 1011, so that the co-axial connector 30 cannot be conveniently locked or unlocked.

The present invention intends to provide a locking tool for a co-axial connector and the locking tool eliminates the shortcomings mentioned above.

### SUMMARY OF THE INVENTION

The present invention relates to a locking tool and comprises a holding portion which is a semi-circular and cylindrical plate. Two first extensions extending from the first distal end of the holding portion. The first extensions each extend radially and outward. At least one notch is defined in the first distal end of the holding portion.

Preferably, a second extension extends from the first distal end of the holding portion and has a curvature the same as that of the holding portion. The first distal end of the holding portion has a shrink and tapered section, the first extensions and the second extension extend from the shrink and tapered section of the first distal end of the holding portion. The at least one notch is defined in the second extension.

Preferably, the two notches are located corresponding to each other.

Preferably, each of the notches is a rectangular note

Preferably, a handle is connected to the second distal end of the holding portion.

The primary object of the present invention is to provide a locking tool for a co-axial connector, wherein the first extensions each are a straight extension and extend radially and outward so that the distance between the two first extensions are larger than the diameter of the body portion. of the co-axial connector which is easily accommodated in the holding portion of the locking tool.

Another object of the present invention is to provide a locking tool for a co-axial connector, wherein the two extending outward first extensions ensure that the two blocks on the co-axial connector are well engaged with the notches of the locking tool. The blocks do not slip away from the notches.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the conventional locking tool and a co-axial connector;

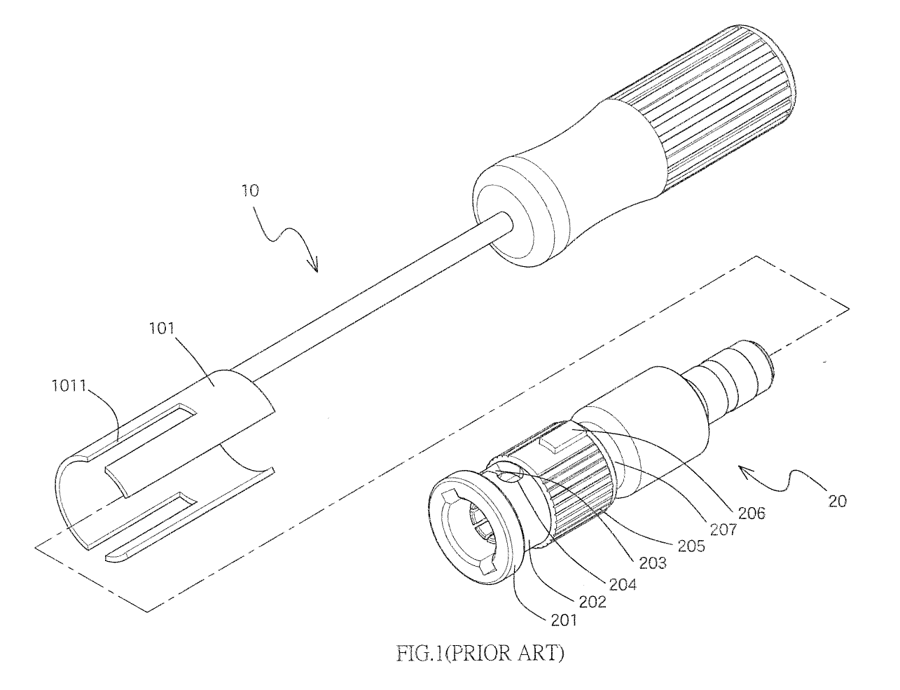

FIG. 2 is a perspective view to show that the conventional locking tool holds the co-axial connector;

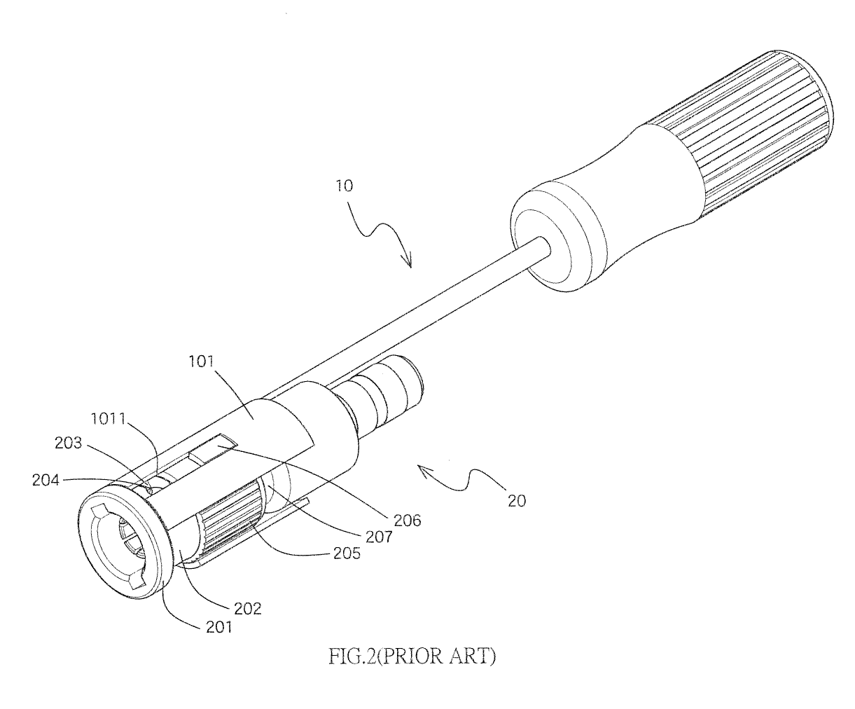

FIG. 3 shows another co-axial connector;

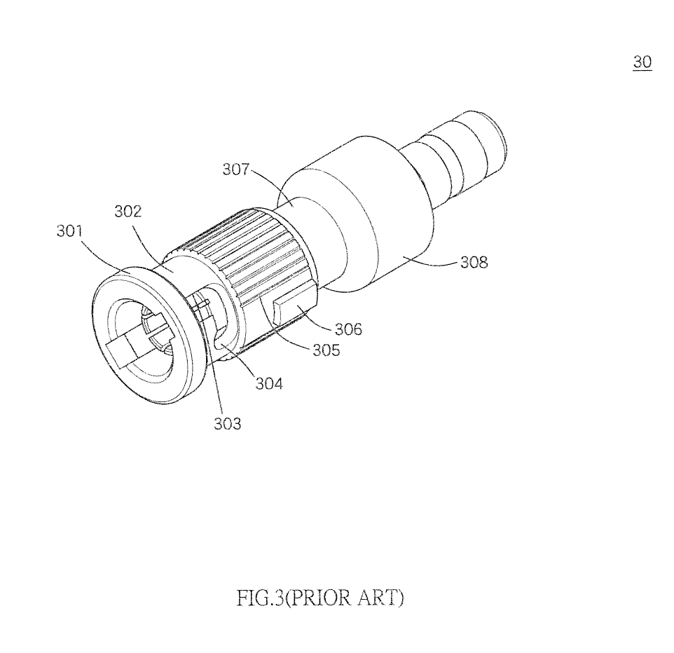

FIG. 4 is an exploded view to show the locking tool of the present invention and the co-axial connector in FIG. 3;

FIG. 5 shows that the locking tool of the present invention is about to hold the co-axial connector in FIG. 3;

FIG. 6 shows that the locking tool of the present invention is moved to engage the blocks on the co-axial connector in FIG. 3 with the notches of the locking tool of the present invention;

FIG. 7 shows that the locking tool of the present invention holds the co-axial connector in FIG. 3;

FIG. 8 is an end cross sectional view, taken along line A-A in FIG. 6;

FIG. 9 shows that the co-axial connector hold by the locking tool of the present invention is moved toward an electric connector, and

FIG. 10 shows that the co-axial connector held by the locking tool of the present invention is rotated an angle to be locked with the electric connector.

### DETAILED DESCRIPTION OF THE PREFERRED EMBODIMENT

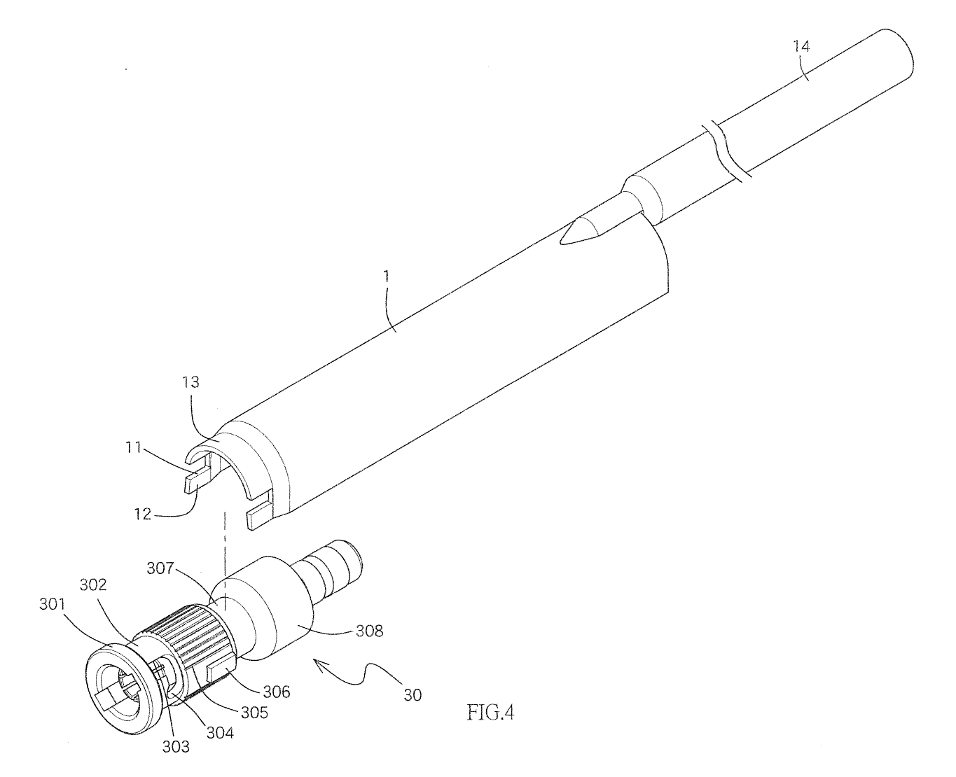

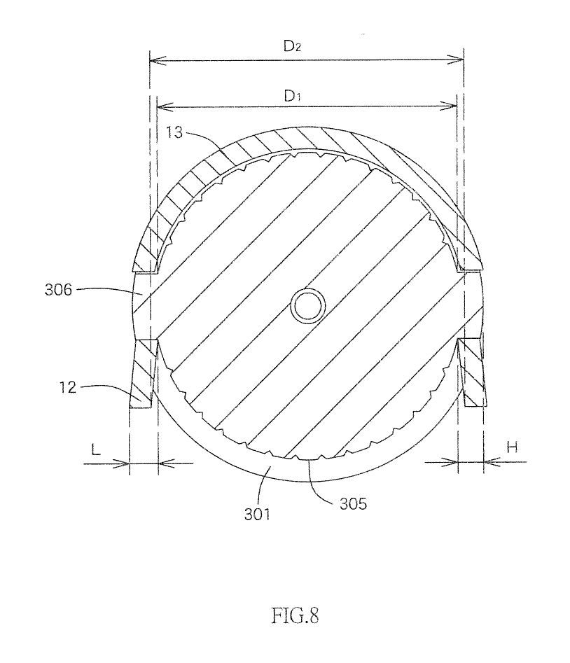

Referring to FIG. 4, the locking tool of the present invention comprises a holding portion 1 which is a semicircular and cylindrical plate. The first distal end of the holding portion 1 has a shrink and tapered section. Two first extensions 12 and a second extension 13 extend from the shrink and tapered section, of the first distal enc of the holding portion 1. The first extensions 12 each are a straight extension and extend radially and outward when viewed from the first distal end of the holding portion 1 as shown in FIG. 8. The second extension 13 has a curvature the same as that of the holding portion 1. Two notches 11 are defined in the second extension 13 of the first distal end of the holding portion 1. The two notches 11 which are located corresponding to each other. A handle 14 is connected to the second distal end of the holding portion 1. As shown in FIG. 4, the diameter of the second body portion 308 is larger than the first body portion 305 of the co-axial connector 30 so that the co-axial connector 30 can be accommodated in the holding portion 1 and the holding portion 1 is matched onto the outside of the second body portion 308.

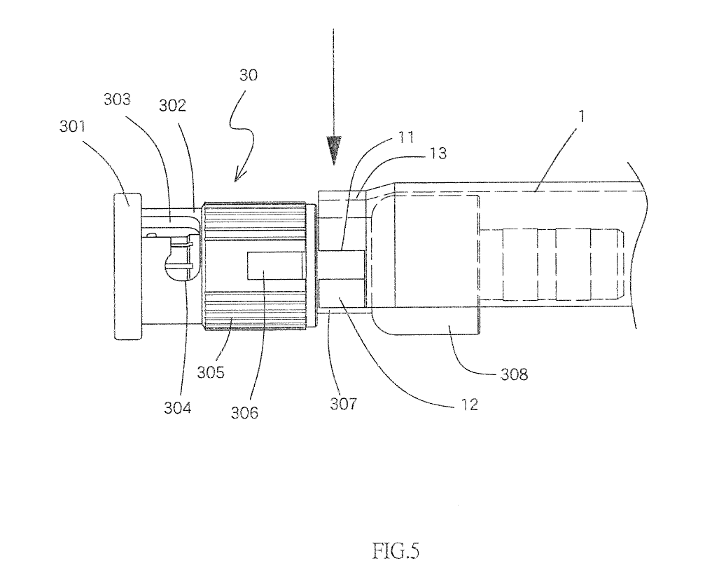

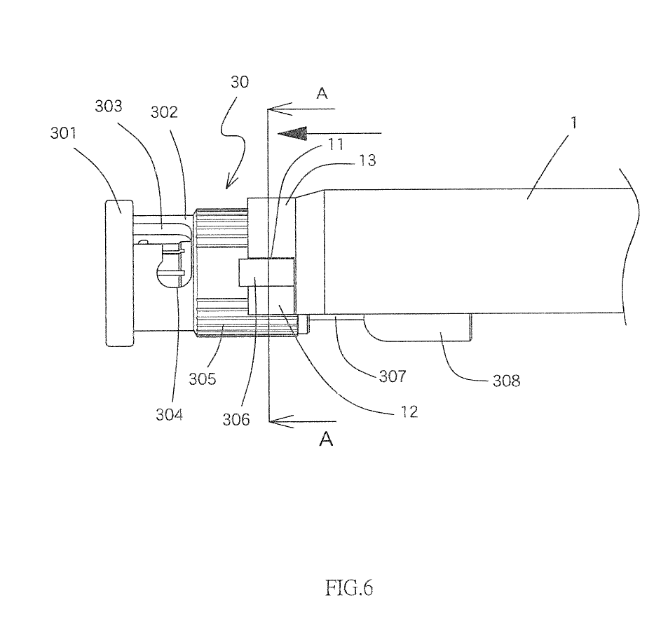

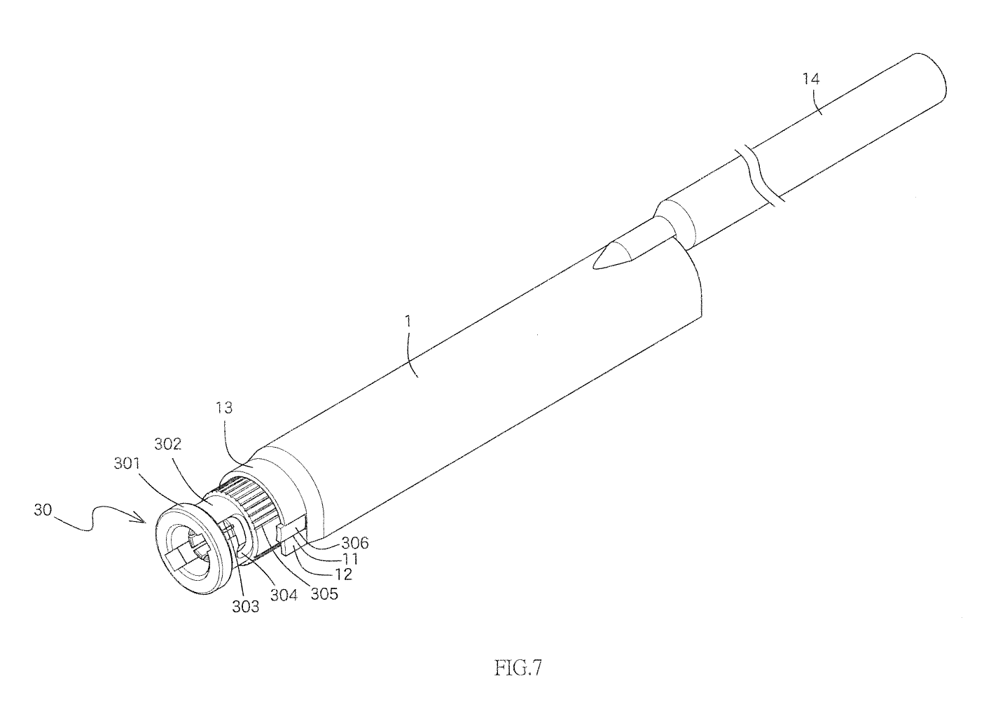

As shown in FIGS. 5 and 6, when in use, the user holds the handle 14 and the co-axial connector 30 is accommodated in the holding portion 1 via the opening of the holding portion 1, and the holding portion 1 is matched onto the outside of the second body portion 308. The holding portion 1 is then moved forward to engage the blocks 306 on the co-axial connector 30 with the notches 11. It is noted that the notches 11 each are a rectangular notch as shown in FIG. 7 and the blocks 306 are rectangular blocks so that the blocks 306 on the co-axial connector 30 are well engaged with the notches 11 so that the co-axial connector 30 does not slip away from the holding portion 1.

As shown in FIG. 8, the first extensions 12 each are a straight extension and extend radially and outward, the diameter of the co-axial connector 30 is D1, and the distance between the two first extensions 12 is D2 which is larger than the D1. The holding portion 1 is easily mounted to the first body portion 305 of the co-axial connector 30, because there is a shrink and tapered section on the first distal end of the holding portion 1, so that the co-axial connector 30 does not disengage from the second extension 13 of the holding portion 1. The distance L between the two first extensions 12 is substantially the same as the distance H between the two respective outsides of the two blocks 306, so at the user can easily rotate the co-axial connector 30 stably.

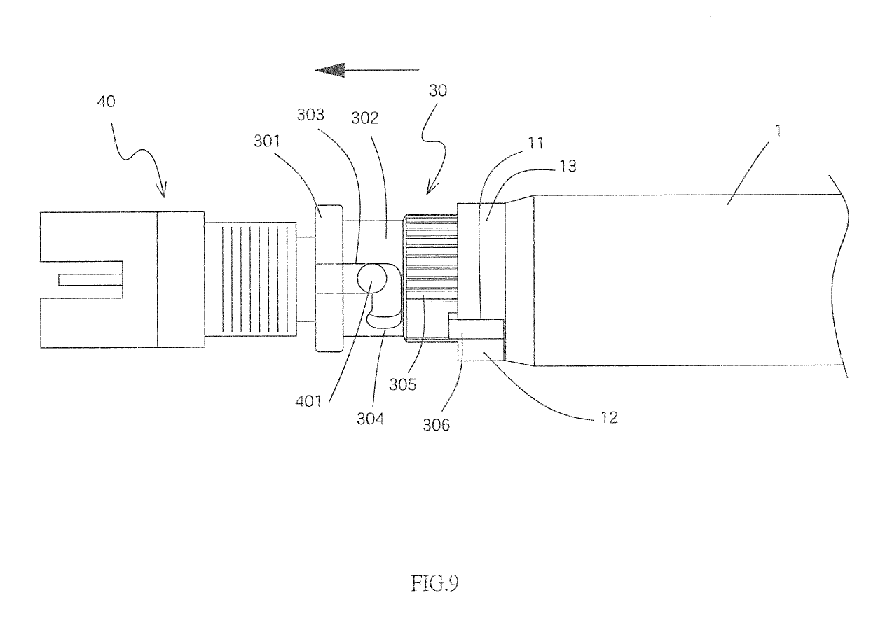

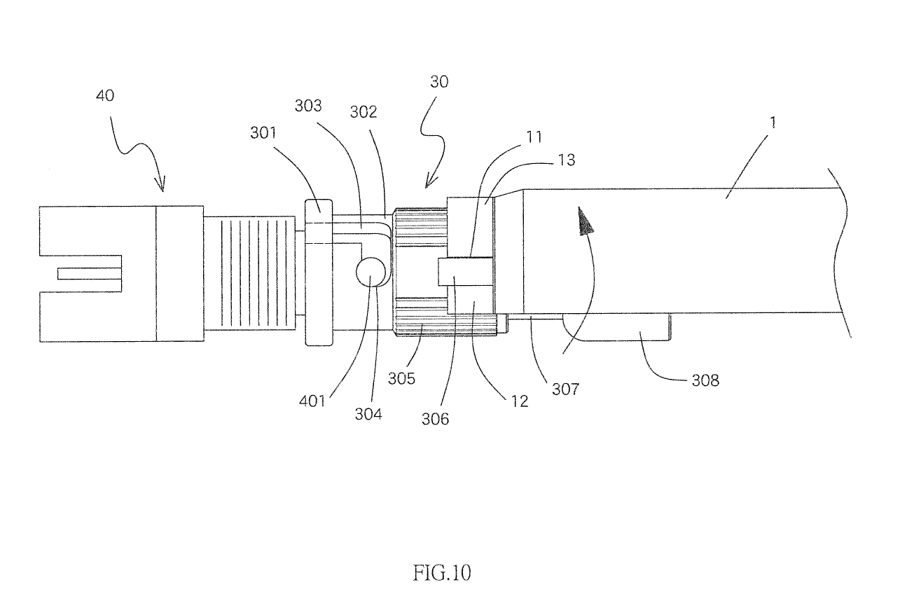

As shown in FIGS. 9 and 10, when the holding portion 1 is matched onto the outside of the second body portion 308 of the co-axial connector 30, and the blocks 306 are engaged with the two notches 11. The co-axial connector 30 is to be connected with an electric connector 40, and a protrusion 401 on the electric connector 40 is moved along the guide slot 303, and the co-axial connector 30 is rotated an angle to guide the protrusion 401 to move along the guide slot 303 and is engaged with the engaging portion 304 of the guide slot 303, such that the co-axial connector 30 does not escape from the electric connector 40.

The advantages of the present invention are that the first extensions 12 extend outward and radially from the holding portion 1 so that the co-axial connector 30 is easily accommodated in the holding portion 1. This feature saves a lot of time when connecting the co-axial connector 30 to the holding portion 1.

The rectangular notches 11 can be properly mounted to the blocks 306 or the first body portion 305 of the coaxial connector 30, such that the co-axial connector 30 does not slip from the holding portion 1.

The distance L between the two first extensions 12 substantially the same as the distance H between the two respective outsides of the two blocks 306, so that the user can easily rotate the coaxial connector 30 stably.

While we have shown and described the embodiment in accordance with the present invention, it should be clear to those skilled in the art that further embodiments may be made without departing from the scope of the present invention.

What is claimed is:

1. A locking tool comprising:
a holding portion being a semi-circular and cylindrical plate, two first extensions extending from a first distal end of the holding portion, the first extensions each extending radially and outward, at least one notch defined in the first distal end of the holding portion.

2. The locking tool as claimed in claim 1, wherein a second extension extends from the first distal end of the holding portion and has a curvature the same as that of the holding portion, the first distal end of the holding portion has a shrink and tapered section, the first extensions and the second extension extend from the shrink and tapered section of the first distal end of the holding portion, the at least one notch is defined in the second extension.

3. The locking tool as claimed in claim 1, wherein there are two notches which are located corresponding to each other.

4. The locking tool as claimed in claim 2, wherein the there are two notches which are located corresponding to each other.

5. The locking tool as claimed in claim 1, wherein the at least one notch is a rectangular notch.

6. The locking tool as claimed in claim 1, wherein the distal end of the holding portion has a shrink and tapered section.

7. The locking tool as claimed in claim 1, wherein a handle is connected to a second distal end of the holding portion.
